(19) United States
(12) Patent Application Publication
(10) Pub. No.: US 2002/0015250 A1
(43) Pub. Date: Feb. 7, 2002

(54) Multi-track digital recording and reproducing apparatus and method, and storage medium

(76) Inventors: Yoshinori Kawase, Hamamatsu-shi (JP); Masato Naito, Hamamatsu-shi (JP)

Correspondence Address: David L. Fehrman, Morrison & Foerster LLP, 35th Floor, 555 W. 5th Street, Los Angeles, CA, 90013, US

(21) Appl. No.: 09/912,959

(22) Filed: Jul. 25, 2001

(30) Foreign Application Priority Data
Jul. 31, 2000 (JP) 2000-267733

(51) Int. Cl. G11B 5/02; G11B 19/02

(52) U.S. Cl. 360/55; 360/69

(57) ABSTRACT

There are provided a digital recording and reproducing apparatus and method which can display a remaining time period available for recording on a track which is designated for recording, and a storage medium storing a program for implementing the method. Whether or not to perform recording is designated for each of a plurality of tracks. The occurrence of an operation event is detected, which designates display of a time period available for recording. In response to the detected occurrence of the operation event, the time period available for recording is calculated based upon a number of tracks which are designated for recording upon the occurrence of the operation event, and a current amount of empty capacity in a storage device that stores recorded data. The calculated time period available for recording is displayed.

### BACKGROUND OF THE INVENTION

1. Field of the Invention

The present invention relates to a digital recording and reproducing apparatus and method which is able to record and reproduce audio data as digital data in an external storage device such as a hard disk device, and a storage medium storing a program for implementation of the method.

2. Description of Related Art

Conventionally, recording and reproducing apparatuses have been known which record various types of audio data as digital data in an external storage device such as a hard disk device, and which reproduce this data. As one type of such recording and reproducing apparatuses, there is known a multi-track recorder which records a plurality of series of input audio data in a plurality of tracks. The audio data recorded in each track can be reproduced by a predetermined operation. Among these multi-track recorders there is one type which displays the range of each track which has been recorded, in a bar graph which extends along the horizontal axis taken as the time axis.

Among these multi-track recorders, there is one type which is provided with a function of displaying the amount of empty capacity in the external storage device for recording audio data, i.e. a function of displaying a so-called remaining space (hereinafter referred to as the “remaining space display function”).

Furthermore, with this type of multi-track recorder, recording and reproducing control such as volume level control can be performed for each track independently.

However, with the above described prior art, since the remaining space display function merely displays the amount of empty capacity available in the external storage device, it has not been possible for the user to know in terms of time the amount of audio data which can be recorded in this empty space.

Furthermore, the information that can be displayed as a bar graph along the time axis is only the range for each track which has been recorded. Therefore, the user has not been able to know the waveform to be formed by the audio data recorded in each track. Sometimes it may happen that this waveform cannot be recognized upon reproduction and audition.

Furthermore, since recording and reproducing control are performed independently for each track, it has not been possible to satisfy the demand for performing recording and reproducing control all together for a plurality of tracks which, for example, have been recorded by stereo recording or multi-microphone recording.

### SUMMARY OF THE INVENTION

It is a first object of the present invention to provide a digital recording and reproducing apparatus and method which can display a remaining time period available for recording on a track which is designated for recording, and a storage medium storing a program for implementing the method.

It is a second object of the present invention to provide a digital recording and reproducing apparatus and method which allows checking for each track according to the recording state based on waveform and setting of the recording start position for each track, and a storage medium storing a program for implementing the method.

A third object of the present invention is to provide a digital recording and reproducing apparatus and method which can control in a collective manner the recording and reproduction state of a plurality of tracks which are grouped into pairs or groups by the use of a single operation element, and a storage medium storing a program for implementing the method.

To attain the first object, a first aspect of the present invention provides a digital recording and reproducing apparatus for recording and reproducing digital audio data, comprising a recording track designating device that designates whether or not to perform recording, for at least one track, a storage device that stores recorded data, an operation event detecting device that detects occurrence of an operation event designating display of a time period available for recording, a recording available time period calculating device that is responsive to the detected occurrence of the operation event, for calculating the time period available for recording, based upon a number of tracks which are designated for recording upon the occurrence of the operation event, and a current amount of empty capacity in the storage device, and a time period display device that displays the calculated time period available for recording.

Preferably, the digital recording and reproducing apparatus according to the first aspect is a multi-track digital recording and reproducing apparatus for recording and reproducing digital audio data in multi-track format, and the recording track designating device designates whether or not to perform recording, for each of a plurality of tracks.

The first aspect of the present invention further provides a digital recording and reproducing method of recording and reproducing digital audio data, comprising a recording track designating step of designating whether or not to perform recording, for at least one track, an operation event detecting step of detecting occurrence of an operation event designating display of a time period available for recording, a recording available time period calculating step of calculating, in response to the detected occurrence of the operation event, the time period available for recording, based upon a number of tracks which are designated for recording upon the occurrence of the operation event, and a current amount of empty capacity in a storage device that stores recorded data, and a time period display step of displaying the calculated time period available for recording.

Preferably, the digital recording and reproducing method according to the first aspect is a multi-track digital recording and reproducing method of recording and reproducing digital audio data in multi-track format, and the recording track designating step comprises designating whether or not to perform recording, for each of a plurality of tracks.

The first aspect of the present invention further provides a computer-readable storage medium storing a program for implementing a digital recording and reproducing method for digital audio data, the program comprising a recording track designation module for designating whether or not to perform recording, for at least one track, an operation event detecting module for detecting occurrence of an operation event designating display of a time period available for recording, a recording available time period calculating module for calculating, in response to the detected occurrence of the operation event, the time period available for recording, based upon a number of tracks which are designated for recording upon the occurrence of the operation event, and a current amount of empty capacity in a storage device that stores recorded data, and a time period display module for displaying the calculated time period available for recording.

Preferably, in the computer-readable storage medium according to the first aspect, the digital recording and reproducing method is a multi-track digital recording and reproducing method of recording and reproducing digital audio data in multi-track format, and the recording track designating module comprises designating whether or not to perform recording, for each of a plurality of tracks.

According to the first aspect of the present invention, since the time period available for recording is calculated from the amount of empty capacity in the storage device and according to the recording setting for a plurality of tracks and is displayed, it is possible to display the remaining amount of recording time in correspondence to the number of tracks which have been designated for recording, and it becomes possible to perform management in conformity to the actual recording situation.

To attain the second object, a second aspect of the present invention provides a digital recording and reproducing apparatus for recording and reproducing digital audio data, comprising a graph display device that displays a graph showing a time period range in which audio data is recorded, for at least one track, a recording start position setting device that sets a recording start position for the at least one track in the displayed graph, a waveform data display device that is responsive to a predetermined operation, for displaying waveform data corresponding to a range including the recording start position, and a setting changing device that changes the setting of the recording start position by setting a position the displayed waveform data.

Preferably, the digital recording and reproducing apparatus according to the second aspect is a multi-track digital recording and reproducing apparatus for recording and reproducing digital audio data in multi-track format, and the graph display device displays a graph showing a time period range in which audio data is recorded, for a plurality of tracks, and the recording start position setting device sets a recording start position for each of the plurality of tracks in the displayed graph.

The second aspect of the present invention further provides a digital recording and reproducing method of recording and reproducing digital audio data, comprising a graph display step of displaying a graph showing a time period range in which audio data is recorded, for at least one track, a recording start position setting step of setting a recording start position for the at least one track in the displayed graph, a waveform data display step of displaying waveform data corresponding to a range including the recording start position, in response to a predetermined operation, and a setting changing step of changing the setting of the recording start position by setting a position the displayed waveform data.

Preferably, the digital recording and reproducing method according to the second aspect is a multi-track digital recording and reproducing method of recording and reproducing digital audio data in multi-track format, and the graph display step comprises displaying a graph showing a time period range in which audio data is recorded, for a plurality of tracks, and the recording start position setting step comprises setting a recording start position for each of the plurality of tracks in the displayed graph.

The second aspect of the present invention further provides a computer-readable storage medium storing a program for implementing a digital recording and reproducing method for digital audio data, the program comprising a graph display module for displaying a graph showing a time period range in which audio data is recorded, for at least one track, a recording start position setting module for setting a recording start position for the at least one track in the displayed graph, a waveform data display module for displaying waveform data corresponding to a range including the recording start position, in response to a predetermined operation, and a setting changing module for changing the setting of the recording start position by setting a position the displayed waveform data.

Preferably, in the computer-readable storage medium according to the second aspect, the digital recording and reproducing method is a multi-track digital recording and reproducing method of recording and reproducing digital audio data in multi-track format, and the graph display module comprises displaying a graph showing a time period range in which audio data is recorded, for a plurality of tracks, and the recording start position setting module comprises setting a recording start position for each of the plurality of tracks in the displayed graph.

According to the second aspect of the present invention, since the waveform corresponding to a range including the recording start position for each track is displayed in response to a predetermined operation when displaying a graph which shows, for each of a plurality of tracks, over what time period range audio data is recorded, it is possible to check the recording state by inspecting the waveform, and moreover, since it is possible to designate the recording start position via this waveform display screen, it is possible to set the recording start position for each track while checking the waveform.

To attain the third object, a third aspect of the present invention provides a digital recording and reproducing apparatus for recording and reproducing digital audio data, comprising a track designating device that designates a number of tracks to be grouped together from a plurality of tracks, an operating element, and a recording and reproducing control device that performs common recording and reproducing control for the grouped together tracks, based upon an output from the operating element.

Preferably, the digital recording and reproducing apparatus according to the third aspect is a multi-track digital recording and reproducing apparatus for recording and reproducing digital audio data in multi-track format.

The third aspect of the present invention further provides a digital recording and reproducing method of recording and reproducing digital audio data, comprising a track designating step of designating a number of tracks to be grouped together from a plurality of tracks, and a recording and reproducing control step of performing common recording and reproducing control for the grouped together tracks, based upon an output from an operating element.

Preferably, the digital recording and reproducing method according to the third aspect is a multi-track digital recording and reproducing method of recording and reproducing digital audio data in multi-track format.

The third aspect of the present invention further provides a computer-readable storage medium storing a program for implementing a digital recording and reproducing method for digital audio data, the program comprising a track designating module for designating a number of tracks to be grouped together from a plurality of tracks, and a recording and reproducing control module for performing common recording and reproducing control for the grouped together tracks, based upon an output from an operating element.

Preferably, in the computer-readable storage medium according to the third aspect, the digital recording and reproducing method is a multi-track digital recording and reproducing method of recording and reproducing digital audio data in multi-track format.

According to the third aspect of the present invention, since a plurality of tracks are grouped together, and common record and reproducing control is performed for this group of tracks with a single operating element, it is possible to control a plurality of tracks which have been recorded by stereo recording or multi-microphone recording in a collective manner.

The above and other objects, features, and advantages of the invention will become more apparent from the following detailed description taken in conjunction with the accompanying drawings.

### BRIEF DESCRIPTION OF THE DRAWINGS

FIG. 1 is a block diagram showing the construction of a multi-track digital recording and reproducing apparatus according to an embodiment of the present invention;

FIG. 2 is a diagram showing the layout of an operating element/display section 104 appearing in FIG. 1;

FIG. 3 is a view showing an initial track view screen which displays the state of each of sixteen tracks;

FIG. 4 is a view showing a track view remaining time display screen which displays the amount of remaining time available for recording;

FIG. 5 is a view showing a track view wave display screen;

FIG. 6 is a view showing a virtual track display screen;

FIG. 7A is a diagram which is useful in explaining recording and reproducing control by a fader during recording;

FIG. 7B is a diagram which is useful in explaining recording and reproducing control by the fader during reproduction;

FIG. 7C is a diagram which is useful in explaining recording and reproducing control by the fader during pairing;

FIG. 8 is a flow chart showing a remaining time display processing routine for performing remaining time display;

FIG. 9 is a flow chart showing a wave display processing routine; and

FIG. 10 is a flow chart showing a track pairing processing routine.

### DETAILED DESCRIPTION OF THE PREFERRED EMBODIMENT

The present invention will now be described with reference to the drawings showing a preferred embodiment thereof.

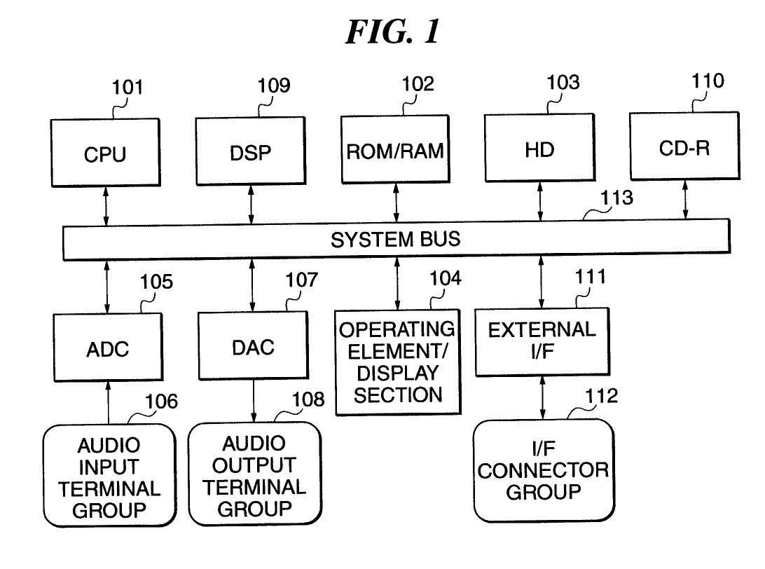

FIG. 1 is a block diagram showing the construction of a multi-track digital recording and reproducing apparatus according to a preferred embodiment of the present invention.

This multi-track digital recording and reproducing apparatus (hereinafter referred to as a “recording and reproducing apparatus”) is comprised of a central processing unit (CPU) 101, a ROM (read only memory)/RAM (random access memory) 102, a hard disk device (HD) 103, an operating element/display section 104, an analog-to-digital converter (ADC) 105, an audio input terminal group 106, a digital-to-analog converter (DAC) 107, an audio output terminal group 108, a digital signal processor (DSP) 109, a CD-R (Compact Disk Recordable) 110, an external interface (I/F) 111, an I/F connector group 112, and a system bus 113.

The CPU 101 controls the overall operation of this recording and reproducing apparatus. The ROM/RAM 102 stores various programs executed by the CPU 101 and is used as a working area. The HD 103 stores programs executed by the CPU 101 and various data which are used in executing the programs, for example, and also has provided therein areas for storing data related to recording of digital audio data. The operating element/display section 104 includes various control elements for actuation by the user, and a display for various kinds of information. This operating element/display section 104 is provided upon an external panel of the recording and reproducing apparatus.

The ADC 105 converts analog audio signals which have been inputted via the audio input terminal group 106 into digital signals. The DAC 107 converts digital audio signals which have been inputted via the system bus 113 into analog signals and then outputs them to the audio output terminal group 108.

The DSP 109 performs various processes such as executing various micro-programs, mixing digital audio signals, processing for adding sound effects, and sound volume level control, in response to commands from the CPU 101. The CD-R 110 records digital audio data which has been recorded on the HD 103 upon a compact disk. The external I/F 111 and the I/F connector group 112 constitute interfaces for connecting external MIDI (Musical Instrument Digital Interface) devices or SCSI (Small Computer Systems Interface) devices, etc.

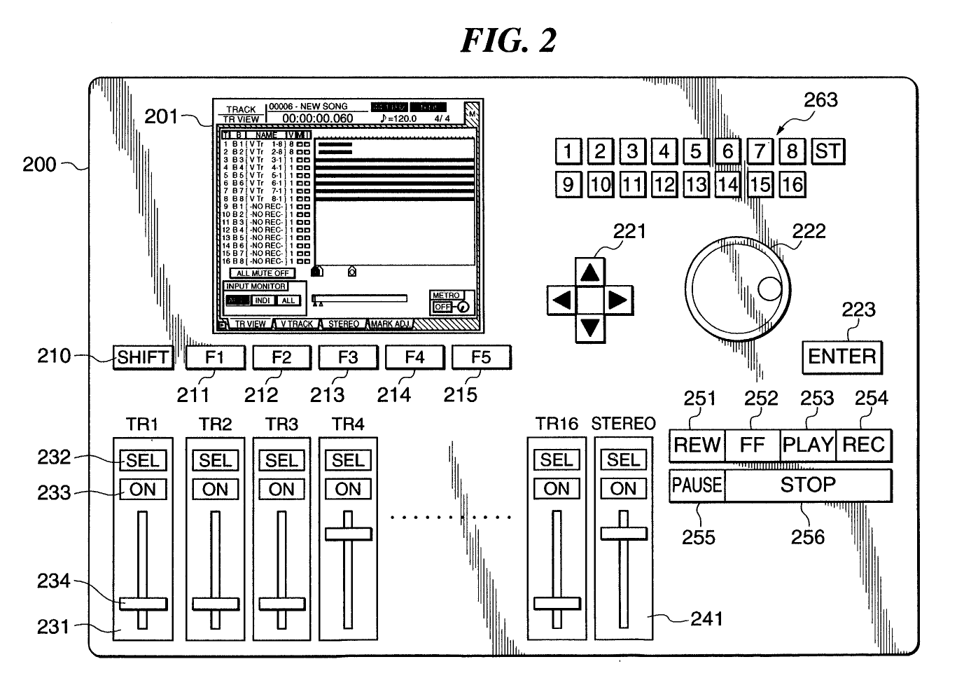

FIG. 2 is a diagram showing the layout of the operating element/display section 104 in FIG. 1.

Reference numeral 201 denotes a display section which is currently displaying a track view screen which will be described hereinafter. Below the display section 201 there are arranged a shift key 210, an F1 key 211, an F2 key 212, an F3 key 213, an F4 key 214, and an F5 key 215. Reference numeral 221 denotes a cursor shift key for shifting a cursor which is displayed upon the display section 201. Reference numeral 222 denotes a data/jog dial for changing the set values of various parameters and for selecting items from lists which are displayed upon the display section 201. Reference numeral 223 denotes an enter key.

This recording and reproducing apparatus is capable of recording and reproducing sixteen tracks, i.e., track #1 to track #16. Signal processing is basically performed by the DSP 109. In each track there are defined eight virtual tracks, i.e., virtual track #1 (hereinafter referred to as “VT1”) to virtual track #8 (hereinafter referred to as “VT8”). Each of these virtual tracks VT is a recording area which is selected during recording and reproduction of the corresponding track. For example, when recording into track #1, first VT1 is recorded, and next VT2 is recorded (with the data in VT1 left as it is); and any desired one of the VTs can be reproduced as track #1, or the data recorded in VTl and the data recorded in VT2 can be mixed and recorded in VT3, and this data in VT3 can be reproduced as track #1. In other words, that VT which is selected from the eight virtual tracks VT1 to VT8 is used for the reproduction of its track.

Reference numeral 231 denotes an operating element set for controlling track #1 (TR1). Reference numeral 232 denotes a SEL key which is used when performing setting of various parameters related to track #1, while 233 denotes an ON key for commanding track #1 to be ON or not, and 234 a fader (a slide volume type operating element which is used for sound volume level control for track #1. Similar operating elements are also provided for the other tracks, i.e. for track #2 (TR2) through track #16 (TR16). Reference numeral 241 denotes an operating element set for performing control related to overall output on two stereo channels. A REW key 251, an FF key 252, a PLAY key 253, a REC key 254, a PAUSE key 255, and a STOP key 256 are, respectively, keys for commanding rewinding, fast forwarding, reproducing, recording, temporary halting, and stopping of operation.

Reference numeral 263 denotes a set of recording track switches for selecting the track to be recorded. When any one of the switches marked as “1” to “16” is turned ON, it becomes possible to record in the correspondingly numbered track.

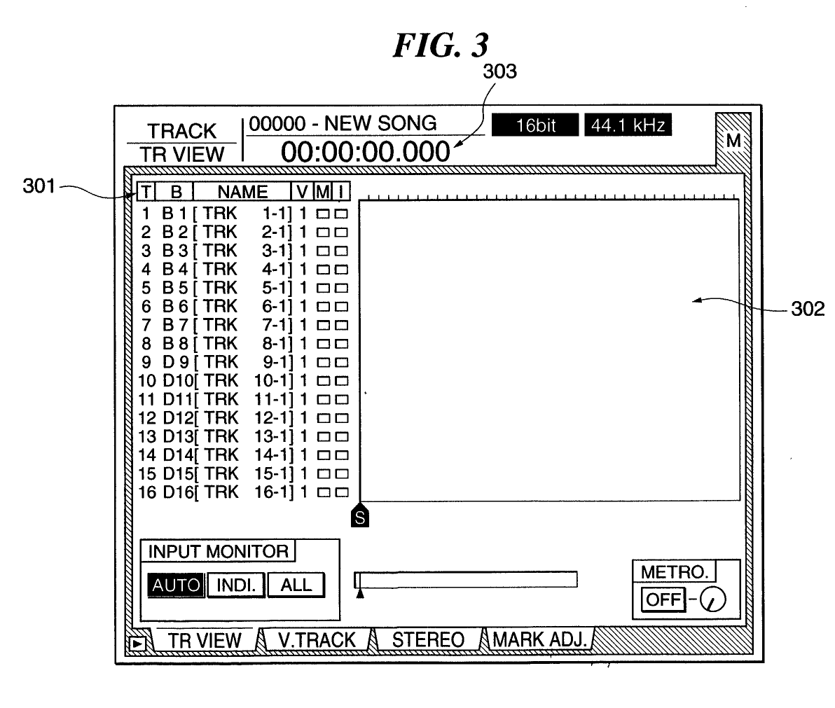

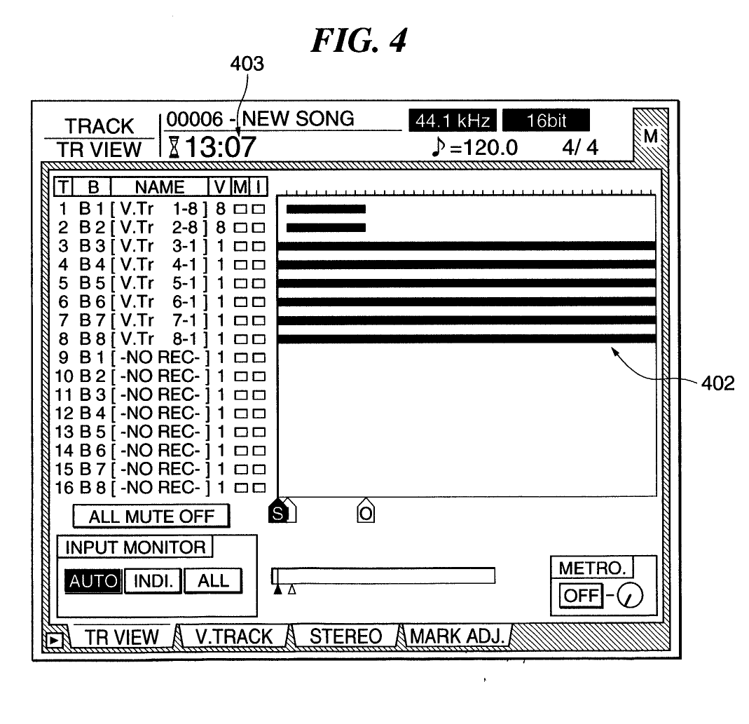

FIG. 3 is a view showing an initial track view screen which displays the state of each of the sixteen tracks. FIG. 4 is a view showing a track view remaining time display screen which displays the amount of remaining time available in which recording is possible.

It is possible to make settings for each track by performing operations upon the initial track view screen of FIG.3.

In the column under “T” in the display screen, denoted by reference numeral 301, a list of numeric characters “1” through “16” for the sixteen tracks is displayed. In the column under “NAME”, a list of names which have been assigned to the tracks is displayed. These names may be changed to any other names desired. A region on the right of these columns, denoted by 302, is for showing the recording state of the tracks in bar graph format. The horizontal direction in this region 302 is the direction of the time axis, and the range which is recorded is shown by a bar graph extending along this direction. In FIG. 3, this region 302 is shown as blank, since in this initial state no track has been recorded. An example of a display by bar graphs is shown at 402 in FIG. 4. In the illustrated example of display, track #1 and track #2 have been partially recorded, while tracks #3 through #8 have been completely recorded (recorded data is present) over the entire time period represented by the complete horizontal range of the display.

Reference numeral 303 in FIG. 3 denotes a recording start position display region in which the recording start position for the track which is currently set is displayed. The recording start position means a position upon the time axis with the start of the entire song being taken as zero, and this position is established for each track. Recording in the track takes place from this position. Accordingly, when reproduction is to be performed, it also takes place from this position. The recording position is displayed as “hour:minute:second”. The seconds are displayed to three places of decimals. In FIG. 3, “00:00:00.000” is displayed, which indicates the start of the song.

From the initial state of this initial track view screen, each track is recorded from its recording start position, and the resulting digital audio data is recorded upon the hard disk device 103. The recording and reproducing apparatus according to the present embodiment can display the remaining empty capacity of the hard disk device 103. Further, it is provided with a recording time period calculating function of calculating the remaining time period during which recording is possible, based upon the number of tracks which have been designated for recording and the empty capacity at the current time point. The calculated remaining time period during which recording is possible is displayed in a remaining recording time display region 403 (see FIG. 4). By doing this, management adapted to the actual state of recording becomes possible.

When predetermined operations are performed from the track view screen (in this case, depressing of the shift key+the F1 key), the recording start position display region 303 in FIG. 3 changes over to the remaining recording time display region 403 in FIG. 4, and the remaining time available for recording is displayed (hereinafter, this will be referred to as the “remaining time display”). In the remaining time display screen shown in FIG. 4, an example of remaining time available for recording is shown. Thus, the display in the remaining recording time display region 403 shows a remaining recording time of 13 minutes and 7 seconds. It should be noted that the recording setting for each track is obtained by depressing the corresponding one of the switches in the recording track switch set 263.

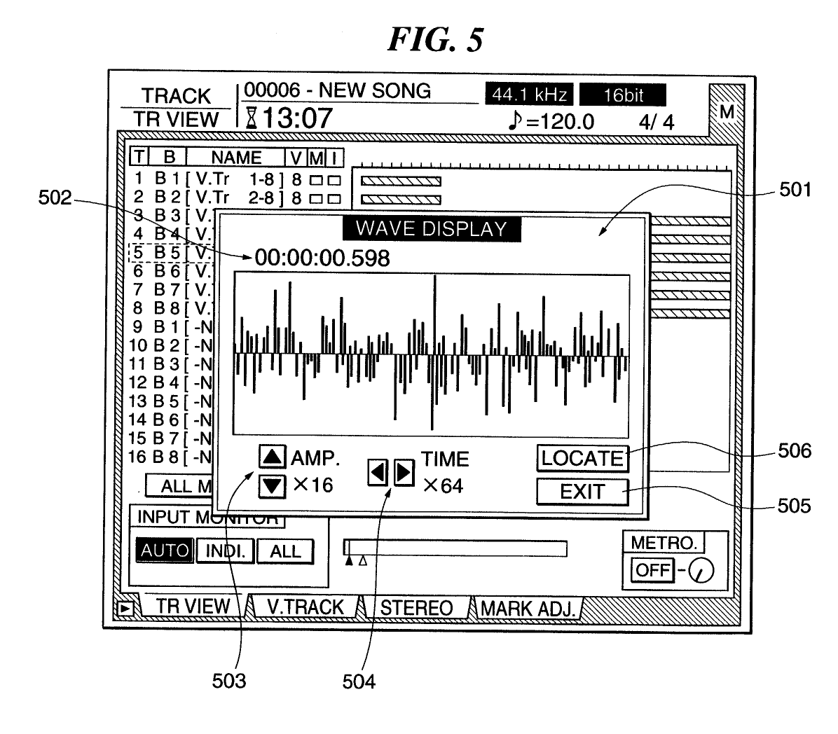

FIG. 5 is a view showing a track view wave (waveform) display screen.

This wave display screen 501 displays a musical tone waveform before and after the current recording start position, which is positioned at its center. When the F2 key is depressed with any one of the tracks selected on the track view screen, the waveform for this selected track pops up as a display upon this wave display screen 501.

In a region 502 at the upper left portion of this wave display screen 501 the current recording start position is displayed. Reference numeral 503 denotes a pair of buttons, marked with an up-arrow and a down-arrow, which are operated when increasing or reducing the display magnification in the vertical direction (amplitude) for the waveform which is being displayed. When the cursor is brought over the up-arrow mark by using the cursor shift key 221 (refer to FIG. 2) and the enter key 223 is depressed, then the magnification in the vertical direction of the waveform which is being displayed is increased. Furthermore, when the cursor is brought over the down-arrow mark and an enter key 223 (refer to FIG. 2) is depressed, then the magnification in the vertical direction of the waveform which is being displayed is reduced. Reference numeral 504 denotes a pair of buttons, marked with a left-arrow and a right-arrow, which are operated when increasing or reducing the display magnification in the time axis direction (the horizontal axis). When the cursor is brought over the right-arrow mark by using the cursor shift key 221 (refer to FIG. 2) and the enter key 223 is depressed, then the magnification in the horizontal direction of the waveform which is being displayed is increased. Furthermore, when the cursor is brought over the left-arrow mark and the enter key 223 is depressed, then the magnification of the waveform in the horizontal direction is reduced. When this waveform display screen 501 is to be erased, the cursor is brought over an EXIT key 505 and the enter key 223 is depressed.

With this wave display screen, it is possible to monitor the waveform at the recording start position. In other words, it is possible to check the recording state in the vicinity of the recording start position by inspecting the waveform. Moreover, it is possible to set the recording start position while checking the waveform via this wave display screen 501. Setting the recording start position is performed by turning ON a recording start button 506 (recording start position setting means).

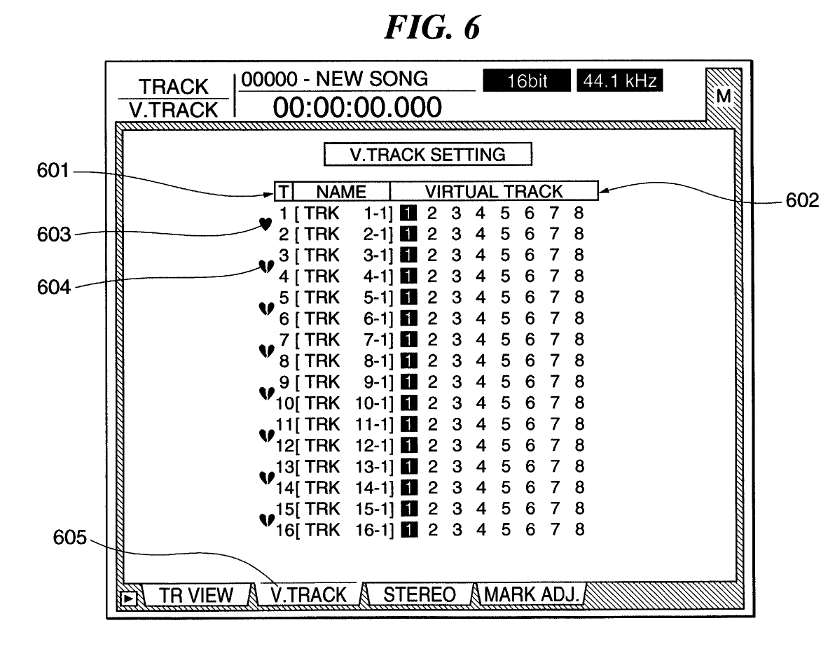

FIG. 6 is a view showing a virtual track display screen.

When the user selects a tab 605 in the layout on the bottom edge of the track view screen using the cursor and depresses the enter key 223, a virtual track view screen as shown in FIG. 6 is displayed. A list of track numbers “1” to “16” and track names which have been assigned, respectively, to the tracks #1 through #16 is displayed in a column “NAME” indicated by reference numeral 601. At the right of the screen, numbers “1” to “8” for the eight virtual tracks (VT) for each track are displayed in a column “VIRTUAL TRACK” indicated by reference numeral 602. A portion of this display which corresponds to the currently allocated VT is highlighted (white on black in the view).

In particular, with the recording and reproducing apparatus according to the present embodiment, the odd numbered tracks and the even numbered tracks can be paired off. Recording and reproducing control for each pair of two tracks is performed together, using a single common fader. The “heart” mark 603 in FIG. 6 indicates that the tracks #1 and #2 are paired together. On the other hand, the “heart struck out” mark 604 indicates that the tracks #3 and #4 are not paired together. The track pairings can be set and cancelled by bringing the cursor to the subject tracks and actuating specified keys.

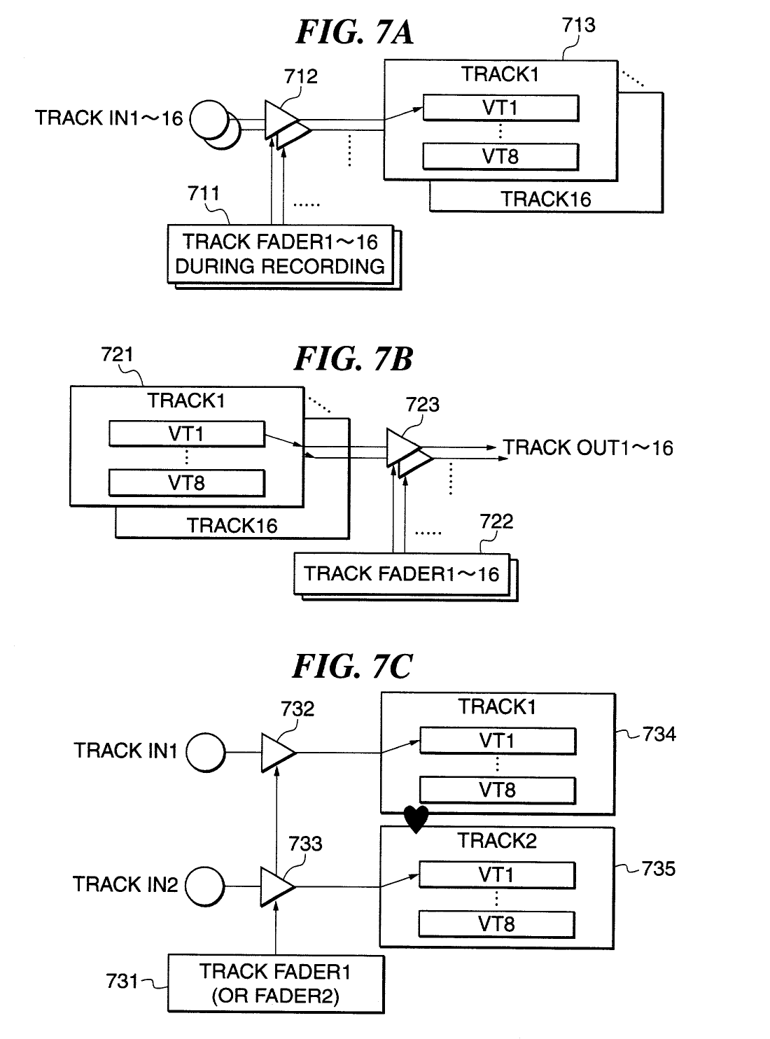

FIG. 7A is a view which is useful in explaining recording and reproducing control by a fader during recording.

As an example, track #1 (713) among the tracks #1 to #16 will be explained. An input signal TRACKIN1 which is inputted to track #1 is processed upon input by a multiplier 712. A value representing an amount by which a fader 1 shown at 711 (TRACKFADER1; corresponding to the fader 234 in FIG. 2) is operated is inputted to the multiplier 712. The multiplier 712 multiplies the input signal by this operation amount, whereby recording control for the input signal is performed. The input signal which has thus been subjected to recording control is recorded in the currently set VT for track #1 (here, VT1). The procedure is the same for the other tracks. Recording control for each track is performed independently using its respective fader.

FIG. 7B is a view which is useful in explaining recording and reproducing control by the fader during reproduction.

An output signal which is read out from VT1 of track #1 is processed by a multiplier 723. A value representing an amount by which the fader 1 shown at 722 is operated is inputted to the multiplier 723. The multiplier 723 multiplies the output signal by this operation amount, whereby reproducing control for the output signal is performed. The output signal which has thus been subjected to reproducing control is outputted as an output TRACKOUT1 for track #1. The procedure is the same for the other tracks. Reproducing control for each track is performed independently using its respective fader.

FIG. 7C is a view which is useful in explaining recording and reproducing control by the fader during pairing.

The case in which track #1 and track #2 are paired together will be explained. Recording control is performed for the input signal TRACKIN1 to track #1 by a multiplier 732 according to a value representing an amount by which the fader 1 (731) is operated, and the resulting signal is recorded in a predetermined VT for track #1 (734). In the same manner, recording control is performed for track #2 by a multiplier 733 according to the same value representing the amount by which the same fader 1 (731) is operated, and the resulting signal is recorded in a predetermined VT for track #2 (735).

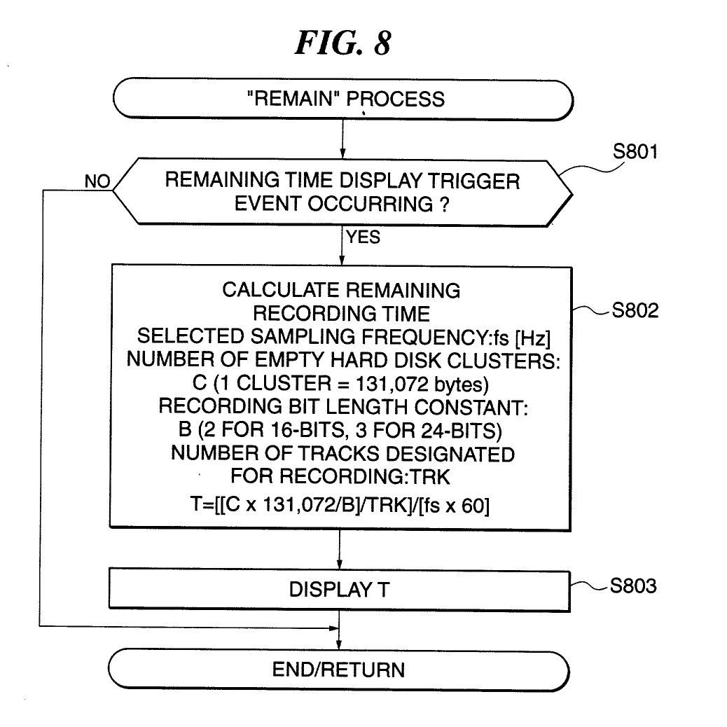

FIG. 8 is a flow chart for a remaining recording time display processing routine for performing the remaining time display.

In a step S801, it is determined whether or not a remaining time display trigger event which commands display of the time remaining for recording is occurring. In this case, it is determined that this remaining time display trigger event is occurring, if the shift key 210 and the F1 key 211 are depressed in the track view screen displayed. When it is determined that this remaining time display trigger event is occurring, then in a step S802 a calculation is performed to determine the amount of recording time remaining (in minutes). This calculation is performed according to the following equation:

T=[[C×131,072/B]/TRK]/[fs×60]

where:

fs is the selected sampling frequency (in Hz);

C is the number of empty hard disk clusters (one cluster=131,072 bytes);

B is a recording bit length constant: for 16-bit recording, B=2, while for 24-bit recording, B=3; and

TRK is the number of tracks designated for recording.

After the step S802, the amount of time T remaining for recording is displayed in a step S803, and then the process returns. If the result of the determination in the step S801 is that the remaining time display trigger event is not occurring, then the process returns directly.

In the above equation, the number of empty bytes on the hard disk is determined as C×131,072, and this is divided by B to obtain the number of samples which can be stored in this empty portion of the hard disk; and then this number of samples is divided by the number TRK of tracks which are designated for being recorded in order to obtain the number of samples for each track which can be stored, and the result is divided by the number of samples [fs×60] in a period of one minute, to obtain the possible length of recording time in units of minutes.

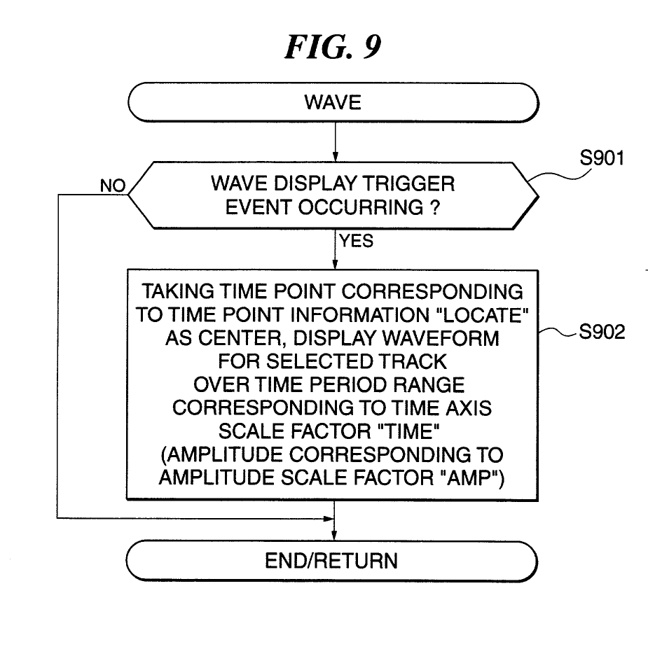

FIG. 9 is a flow chart for a wave display processing routine.

In a step S901, it is determined whether or not a wave display trigger event is occurring. In this case, as described above, it is determined that this wave display trigger event is occurring, if the F2 key 212 is depressed in the track view screen displayed. If it is determined that this wave display trigger event is occurring, then in a step S902, a waveform for the selected track over a time period range corresponding to a time axis scale factor TIME is displayed taking as a center the recording start position, i.e. a time point which corresponds to time point information LOCATE. The waveform is displayed with amplitude corresponding to an amplitude scale factor AMP. After the step S902, the process returns; or, if the result of the determination in the step S901 is that the wave display trigger event is not occurring, then the process returns directly.

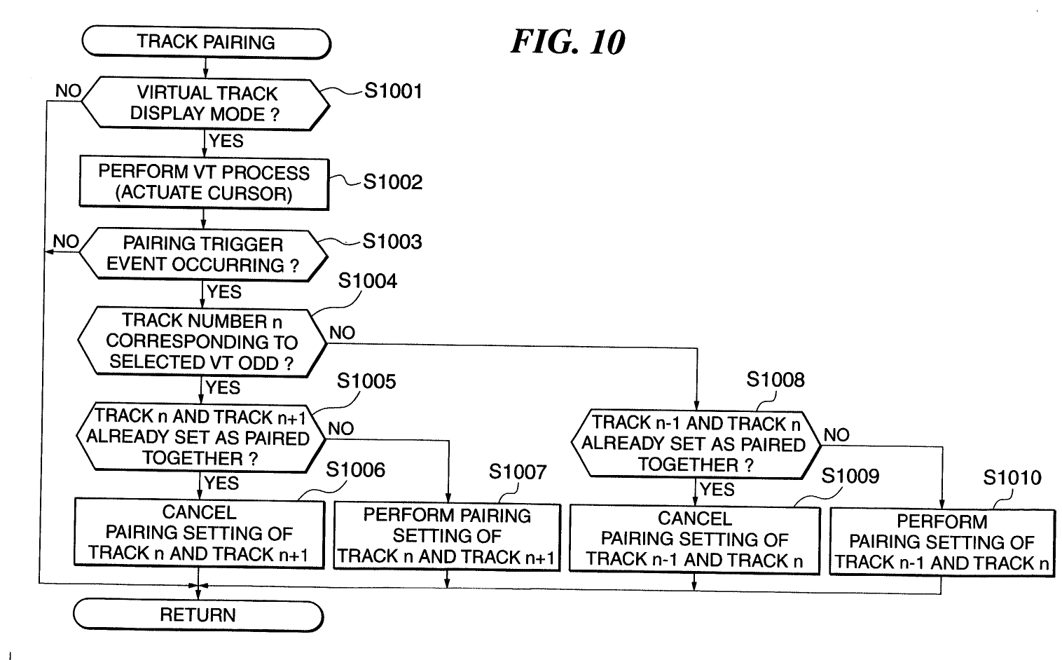

FIG. 10 is a flow chart for the track pairing processing routine which has been explained with reference to FIG. 6.

In a step S1001, it is determined whether or not the currently active mode is a virtual track display mode. If the virtual track display mode is not the current one, then the process returns immediately. If the result of the determination is that the virtual track display mode is the current one, then in a step S1002 a VT selection process is performed. This is done by selecting VTs of tracks to which the cursor has been shifted.

Next in a step S1003, it is determined whether or not a pairing trigger event is occurring. If it is determined that this pairing trigger event is occurring, then in-a step S1004 it is determined whether or not the track number n which corresponds to one of the selected VTs is an odd number. If it is an odd number, then in a step S1005 it is determined whether or not track n and track n+1 are already set as paired together. If they are already paired together, then in a step S1006 the pairing setting of track n and track n+1 is canceled, and the process returns. If the result of the determination in the step S1005 is that track n and track n+1 are not currently set as paired together, then in a step S1007 pairing setting for track n and track n+1 is performed, and the process returns. If the result of the determination in the step S1004 is that the track number n which corresponds to the selected virtual track is not an odd number, then in a step S1008 it is determined whether or not track n−1 and track n are already set as paired together. If they are already paired together, then in a step S1009 the pairing setting of track n−1 and track n is canceled, and the process returns. If the result of the determination in the step S1008 is that track n−1 and track n are not currently set as paired together, then in a step S1010 pairing setting for track n−1 and track n is performed, and the process returns.

By executing the above procedure, it is possible to perform setting and cancellation of pairing as appropriate. The levels of the tracks for which pairing is set can be controlled by using a single fader, as explained in FIG. 7C. It should be noted that, although in the above described embodiment two tracks are formed into a pair, it is possible, without departing from the scope of the present invention, for three or more tracks to be grouped into a set, and for recording and reproducing control for the set to be performed by using a single fader.

It goes without saying that the objects of the present invention may be accomplished by installing program codes of software realizing the functions of the multi-track digital recording and reproducing apparatus of the above described embodiment, from a storage medium in which the program codes are recorded into electronic equipment, such as a personal computer (PC), and causing a computer (or CPU) of the electronic equipment to execute the program.

In this case, the program codes themselves which are installed in the electronic equipment by using the storage medium achieve the novel functions of the present invention, and the storage medium storing the program codes constitutes the present invention.

The storage medium for recording the program codes may be a floppy disk, a hard disk, an optical memory disk, an magneto-optical disk, a CD-ROM, a CD-R (CD-Recordable), a magnetic tape, a nonvolatile memory card, or a ROM for instance. Also, the program codes may be supplied from a server computer through a communication network.

It goes without saying that the present invention encompasses a case in which the functions of the illustrated embodiment are accomplished not only by executing the program codes read out by the computer, but also by causing an OS operating on the computer to perform a part or all of actual operations according to the instructions of the program codes.

Further, the present invention also encompasses a case in which the program codes read out from the storage medium are written into a memory provided in an expanded function board inserted in the PC or in an expanded function unit connected thereto, and then the CPU or the like integrated in the expanded function board or expanded function unit actually performs a part of or all of the operations, based on the instructions of the program codes, so as to accomplish the functions of the illustrated embodiment.

What is claimed is:

1. A digital recording and reproducing apparatus for recording and reproducing digital audio data, comprising:
a recording track designating device that designates whether or not to perform recording, for at least one track;
a storage device that stores recorded data;
an operation event detecting device that detects occurrence of an operation event designating display of a time period available for recording;
a recording available time period calculating device that is responsive to the detected occurrence of the operation event, for calculating the time period available for recording, based upon a number of tracks which are designated for recording upon the occurrence of the operation event, and a current amount of empty capacity in said storage device; and
a time period display device that displays the calculated time period available for recording.

2. A digital recording and reproducing apparatus as claimed in claim 1, which is a multi-track digital recording and reproducing apparatus for recording and reproducing digital audio data in multi-track format, and wherein said recording track designating device designates whether or not to perform recording, for each of a plurality of tracks.

3. A digital recording and reproducing apparatus for recording and reproducing digital audio data, comprising:
a graph display device that displays a graph showing a time period range in which audio data is recorded, for at least one track;
a recording start position setting device that sets a recording start position for the at least one track in the displayed graph;
a waveform data display device that is responsive to a predetermined operation, for displaying waveform data corresponding to a range including the recording start position; and
a setting changing device that changes the setting of the recording start position by setting a position the displayed waveform data.

4. A digital recording and reproducing apparatus as claimed in claim 3, which is a multi-track digital recording and reproducing apparatus for recording and reproducing digital audio data in multi-track format, and wherein said graph display device displays a graph showing a time period range in which audio data is recorded, for a plurality of tracks, and said recording start position setting device sets a recording start position for each of the plurality of tracks in the displayed graph.

5. A digital recording and reproducing apparatus for recording and reproducing digital audio data, comprising:
a track designating device that designates a number of tracks to be grouped together from a plurality of tracks;
an operating element; and
a recording and reproducing control device that performs common recording and reproducing control for the grouped together tracks, based upon an output from said operating element.

6. A digital recording and reproducing apparatus as claimed in claim 5, which is a multi-track digital recording and reproducing apparatus for recording and reproducing digital audio data in multi-track format.

7. A digital recording and reproducing method of recording and reproducing digital audio data, comprising:
a recording track designating step of designating whether or not to perform recording, for at least one track;
an operation event detecting step of detecting occurrence of an operation event designating display of a time period available for recording;
a recording available time period calculating step of calculating, in response to the detected occurrence of the operation event, the time period available for recording, based upon a number of tracks which are designated for recording upon the occurrence of the operation event, and a current amount of empty capacity in a storage device that stores recorded data; and
a time period display step of displaying the calculated time period available for recording.

8. A digital recording and reproducing method as claimed in claim 7, which is a multi-track digital recording and reproducing method of recording and reproducing digital audio data in multi-track format, and wherein said recording track designating step comprises designating whether or not to perform recording, for each of a plurality of tracks.

9. A digital recording and reproducing method of recording and reproducing digital audio data, comprising:
a graph display step of displaying a graph showing a time period range in which audio data is recorded, for at least one track;
a recording start position setting step of setting a recording start position for the at least one track in the displayed graph;
a waveform data display step of displaying waveform data corresponding to a range including the recording start position, in response to a predetermined operation; and
a setting changing step of changing the setting of the recording start position by setting a position the displayed waveform data.

10. A digital recording and reproducing method as claimed in claim 9, which is a multi-track digital recording and reproducing method of recording and reproducing digital audio data in multi-track format, and wherein said graph display step comprises displaying a graph showing a time period range in which audio data is recorded, for a plurality of tracks, and said recording start position setting step comprises setting a recording start position for each of the plurality of tracks in the displayed graph.

11. A digital recording and reproducing method of recording and reproducing digital audio data, comprising:
a track designating step of designating a number of tracks to be grouped together from a plurality of tracks; and
a recording and reproducing control step of performing common recording and reproducing control for the grouped together tracks, based upon an output from an operating element.

12. A digital recording and reproducing method as claimed in claim 11, which is a multi-track digital recording and reproducing method of recording and reproducing digital audio data in multi-track format.

13. A computer-readable storage medium storing a program for implementing a digital recording and reproducing method for digital audio data, said program comprising:
a recording track designation module for designating whether or not to perform recording, for at least one track;
an operation event detecting module for detecting occurrence of an operation event designating display of a time period available for recording;
a recording available time period calculating module for calculating, in response to the detected occurrence of the operation event, the time period available for recording, based upon a number of tracks which are designated for recording upon the occurrence of the operation event, and a current amount of empty capacity in a storage device that stores recorded data; and
a time period display module for displaying the calculated time period available for recording.

14. A computer-readable storage medium as claimed in claim 13, wherein said digital recording and reproducing method is a multi-track digital recording and reproducing method of recording and reproducing digital audio data in multi-track format, and said recording track designating module comprises designating whether or not to perform recording, for each of a plurality of tracks.

15. A computer-readable storage medium storing a program for implementing a digital recording and reproducing method for digital audio data, said program comprising:
a graph display module for displaying a graph showing a time period range in which audio data is recorded, for at least one track;
a recording start position setting module for setting a recording start position for the at least one track in the displayed graph;
a waveform data display module for displaying waveform data corresponding to a range including the recording start position, in response to a predetermined operation; and
a setting changing module for changing the setting of the recording start position by setting a position the displayed waveform data.

16. A computer-readable storage medium as claimed in claim 15, wherein said digital recording and reproducing method is a multi-track digital recording and reproducing method of recording and reproducing digital audio data in multi-track format, and wherein said graph display module comprises displaying a graph showing a time period range in which audio data is recorded, for a plurality of tracks, and said recording start position setting module comprises setting a recording start position for each of the plurality of tracks in the displayed graph.

17. A computer-readable storage medium storing a program for implementing a digital recording and reproducing method for digital audio data, said program comprising:
a track designating module for designating a number of tracks to be grouped together from a plurality of tracks; and
a recording and reproducing control module for performing common recording and reproducing control for the grouped together tracks, based upon an output from an operating element.

18. A computer-readable storage medium as claimed in claim 17, wherein said digital recording and reproducing method is a multi-track digital recording and reproducing method of recording and reproducing digital audio data in multi-track format.
